(19) United States
(12) Patent Application Publication
(10) Pub. No.: US 2009/0091929 A1
(43) Pub. Date: Apr. 9, 2009

(54) DIRECTIONAL L.E.D. LIGHTING UNIT FOR RETROFIT APPLICATIONS

(75) Inventor: LEO E. FAUBION, GREENVILLE, TX (US)

Correspondence Address: HOWISON & ARNOTT, L.L.P, P.O. BOX 741715, DALLAS, TX, 75374-1715, US

(73) Assignee: FAUBION ASSOCIATES, INC., DALLAS, TX (US)

(21) Appl. No.: 12/243,798

(22) Filed: Oct. 1, 2008

Related U.S. Application Data
(60) Provisional application No. 60/977,963, filed on Oct. 5, 2007.

(51) Int. Cl. F21V 33/00

(52) U.S. Cl. 362/234

(57) ABSTRACT

An adjustable light emitting diode (LED) lighting unit adapted for installation in a light fixture is disclosed. In one example, the lighting unit includes first and second end assemblies adapted to interfit with first and second portions, respectively, of the light fixture. A substrate is mounted between the first and second end assemblies and includes electrically conductive paths that are electrically coupled to the light fixture via at least one of the first and second end assemblies. A plurality of LED units are positioned on the substrate and coupled to the electrically conductive paths of the substrate. The first and second end assemblies are configured to allow rotation of the substrate relative to the first and second portions, respectively, of the light fixture.

### CROSS-REFERENCE TO RELATED APPLICATIONS

This application claims the benefit of U.S. Provisional Application Ser. No. 60/977,963, filed Oct. 5, 2007, and entitled DIRECTIONAL L.E.D. LIGHTING UNIT FOR RETROFIT APPLICATIONS, the specification of which is incorporated herein by reference.

### TECHNICAL FIELD

The following disclosure relates to light bulbs and lighting units, and in particular to light emitting diode (“LED”) lighting units configured to serve as retrofit replacements for conventional fluorescent and/or incandescent bulbs having a generally tubular form factor. More particularly, the disclosure relates to retrofit LED lighting units having directional light output, the direction of which is user-adjustable. Some of the disclosed LED lighting units may be suitable for new construction as well as retrofit applications.

### BACKGROUND

Light emitting diode (“L.E.D.” or “LED”) lighting units are known which are configured to serve as retrofit replacements for conventional fluorescent bulbs or incandescent bulbs. For purposes of this disclosure, the term “retrofit replacement” means an LED lighting unit having the same general form factor (i.e., external dimensions and configuration), contact layout, and electrical requirements as the conventional fluorescent or incandescent bulb being replaced. In other words, a retrofit LED lighting unit can be mounted in a conventional light fixture designed for a conventional bulb, it will connect to the light fixture using contacts having the same pattern as the conventional bulb, and it will operate at the voltages supplied by the conventional light fixture.

One application for retrofit LED lighting units is replacing tubular fluorescent bulbs and tubular incandescent bulbs used for interior lighting in store display cases. In display case applications, directional lighting is preferred to most favorably illuminate the items being displayed. Since fluorescent and incandescent bulbs with a tubular form factor generally have an omni-directional light output, reflectors may be provided as part of a display case lighting fixture to direct and/or focus the light from the conventional tubular bulbs in the desired direction. In contrast, retrofit LED lighting units with a tubular form factor typically have a light output that is inherently directional without the need for reflectors. While this may appear to be an advantage, in many cases the physical and electrical connections of the pre-existing display case light fixture will hold the retrofit LED lighting unit in a single, fixed position. Since the pre-existing light fixture was designed to hold a conventional tubular (i.e., omni-directional output) bulb, the position in which it holds the LED lighting unit will not necessarily “point” (i.e., direct the light of) the LED lighting unit in the desired direction. Further, the display case reflectors provided for conventional bulbs will typically be ineffective to direct the light from the retrofit LED unit in the desired direction and may even block the directed light from an area of the display case. In such cases, the light fixture may have to be removed and remounted or modified in order to “re-aim” the directional light output from the LED lighting unit in the desired direction.

Remounting or modifying a pre-existing display case light fixture to adjust the light output direction of a retrofit LED lighting unit can be time consuming and thus expensive. A need therefore exists, for a generally tubular form factor retrofit LED lighting unit having directional light output, the direction of which can be adjusted after the lighting unit is installed in a pre-existing light fixture.

Further, each time the arrangement within a display case changes, it may be desirable to change the light output direction of the LED lighting unit. It may be desirable for these changes to be performed by store personnel rather than by equipment installers. A need therefore exists for a generally tubular form factor retrofit LED lighting unit having directional light output, the direction of which is adjustable manually (i.e., by hand alone, without using tools) through a range of angles.

### SUMMARY

In one embodiment of the present disclosure, a lighting unit is provided. The lighting unit is adapted for installation in a light fixture that includes at least one socket containing electrical contacts. The lighting unit comprises a first end assembly adapted to interfit with a first portion of the light fixture that contains the socket, wherein the first end assembly includes electrically conductive contacts adapted to operably interfit with the socket. A second end assembly is coupled to the second end and adapted to interfit with a second portion of the light fixture. A substrate is mounted between the first and second end assemblies and includes electrically conductive paths. The first and second end assemblies are configured to allow rotation of the substrate relative to the first and second portions, respectively, of the light fixture. A plurality of light emitting diode (LED) units are positioned on the substrate, wherein each LED unit is coupled to the electrically conductive paths of the substrate. An electrical transmission path couples the electrically conductive contacts in the first end assembly with the electrically conductive paths of the substrate.

In another embodiment of the present disclosure, an end assembly for an adjustable light emitting diode (LED) lighting unit is provided. The end assembly comprises a first portion configured to be coupled to at least one of a sidewall of the LED lighting unit and a substrate of the LED lighting unit, the first portion including a first electrical transmission path. A second portion is configured to be coupled to an electrical receptacle of a fluorescent light fixture, the second portion having at least one conductive extension configured to engage the electrical receptacle and a second electrical transmission path coupling the conductive extension and the first electrical transmission path. One of the first and second portions includes a selective adjustment mechanism adapted to allow at least one of an angle of rotation and an offset distance of an LED unit located on the substrate to be altered between first and second positions relative to the fluorescent light fixture.

In still another embodiment of the present disclosure, a lighting unit adapted for installation in a light fixture that includes at least one socket containing electrical contacts is provided. The lighting unit comprises a sidewall extending between first and second ends, the sidewall at least partially defining a cavity and having at least one aperture formed therein to provide access to the cavity. A first end assembly is coupled to the first end and adapted to interfit with a first portion of the light fixture that contains the socket and a second end assembly is coupled to the second end and adapted to interfit with a second portion of the light fixture. A substrate is mounted in the cavity between the first and second end assemblies and extends generally longitudinally behind the aperture. The substrate includes electrically conductive paths. A plurality of light emitting diode (LED) units are positioned on the substrate proximate to the aperture such that light produced by each LED unit is directed through the aperture. Each LED unit is coupled to the electrically conductive paths of the substrate. An electrical transmission path couples the electrically conductive contacts in the first end assembly with the electrically conductive paths of the substrate. The lighting unit also includes means for selectively adjusting at least one of an angle of rotation and an offset distance of at least one of the plurality of LED units relative to the light fixture.

### BRIEF DESCRIPTION OF THE DRAWINGS

For a more complete understanding, reference is now made to the following description taken in conjunction with the accompanying drawings in which:

FIG. 1 illustrates a front perspective view of one embodiment of an adjustable LED lighting unit;

FIG. 2a illustrates a cross-sectional view of one embodiment of the LED lighting unit of FIG. 1 taken along line 2a-2a of FIG. 1;

FIG. 2b illustrates a cross-sectional side view of one embodiment of the LED lighting unit of FIG. 1 taken along line 2b-2b of FIG. 1;

FIGS. 2c and 2d illustrate embodiments of fan placement that may be used to provide cooling to the LED lighting unit of FIG. 1;

FIG. 2e is a diagram illustrating one embodiment of an environment within which the LED lighting unit of FIG. 1 may be used;

FIG. 2f illustrates a cross-sectional side view of another embodiment of the LED lighting unit of FIG. 1;

FIG. 2g illustrates a cross-sectional side view of yet another embodiment of the LED lighting unit of FIG. 1;

FIG. 2h illustrates a cross-sectional side view of an LED lighting unit in accordance with a further embodiment;

FIG. 2i illustrates a cross-sectional side view of an LED lighting unit in accordance with a further embodiment;

FIG. 2j illustrates an LED lighting unit having a defined angular lighting aperture in accordance with another embodiment;

FIG. 3 illustrates a perspective view of one embodiment of an end assembly of the LED lighting unit of FIG. 1;

FIGS. 4a-4d illustrate various views of one embodiment of a portion of the end assembly of FIG. 3;

FIGS. 5a and 5b illustrate various views of one embodiment of another portion of the end assembly of FIG. 3;

FIGS. 6a-6d illustrate various views of one embodiment of a contact member that may form part of the end assembly portion of FIGS. 5a and 5b;

FIG. 6e illustrates an alternative embodiment of a contact member;

FIGS. 7a and 7b illustrate perspective views of the contact member of FIGS. 6a-6d in non-extended and extended positions, respectively, relative to an end assembly of the LED lighting unit of FIG. 1;

FIG. 7c illustrates a perspective view of the contact member of FIGS. 6a-6d in an extended position relative to an end assembly of the LED lighting unit of FIG. 1, where a set screw is used to control an amount of extension;

FIG. 7d illustrates a perspective view of a telescoping embodiment of the contact member of FIGS. 6a-6d in a partially extended position; and

FIGS. 8a and 8b illustrate a fastener and a conductive contact that may be used in the LED lighting unit of FIG. 1.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

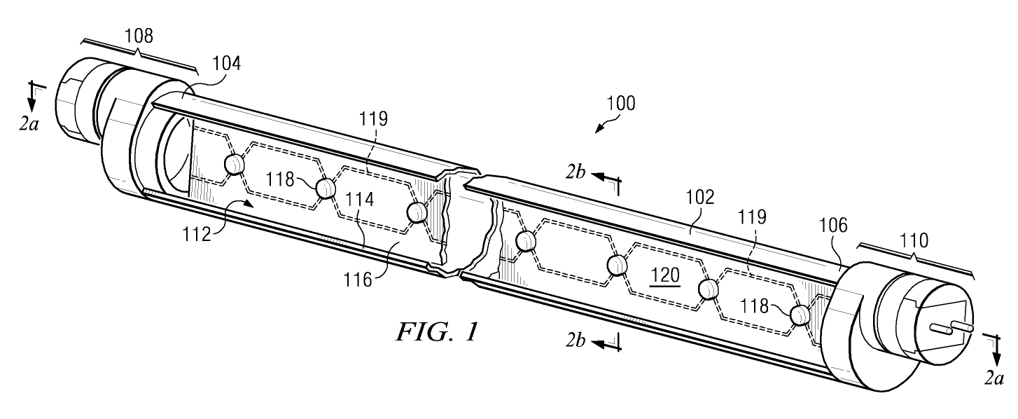

Referring to FIG. 1, one embodiment of an LED lighting unit 100 is illustrated. As will be described in greater detail below, the LED lighting unit 100 may have a generally tubular form factor with double prong-type contacts at each end, similar to that of a standard T-5 or T-8 fluorescent lamp, although it is understood that other form factors including (but not limited to) T-2 and T-12 lamps may be used. LED lighting unit 100 includes a generally tubular sidewall 102 extending between a first end 104 and a second end 106. First and second ends 104 and 106 are coupled to end assemblies 108 and 110, respectively. Sidewall 102 and end assemblies 108 and 110 define a cavity 112 that is accessible via an aperture 114. In the present example, the aperture 114 is a substantially rectangular slit that extends the entire length of the sidewall 102, but it is understood that the aperture may be differently shaped and/or sized and that multiple apertures may be present. In other embodiments, sidewall 102 may include end covers (not shown) and may therefore define cavity 112 without the need for end assemblies 108 and 110.

A substrate 116 includes a plurality of LED units 118 that are integrated with or mounted upon a surface 120 of the substrate 116. The substrate 116 may be mounted in the cavity 112 in a manner that aligns one or more of the LED units 118 with the aperture 114, thereby positioning the LED units 118 to direct light out of the LED lighting unit 100 via the aperture. Electrically conductive paths 119 (e.g., traces) may formed within or on the substrate 116 to couple the LED units 118 to an electrical source (not shown), or wiring may be coupled to or embedded within the substrate to provide such electrically conductive paths.

The configuration of LED units 118 shown in FIG. 1 is representative of many possible LED unit configurations, and such configurations may include varying numbers, colors, and arrangements of LED units. For example, while illustrated as a 1×N array, the LED units 118 may be arranged in various M×N relationships, where M and N are greater than or equal to one (although gaps in the array may exist where no LED is present). The LED units 118 may be packaged individually or may be packaged in groups, such as in a single tri-color LED package. In some embodiments, the configuration of the LED units may vary based on a shape (e.g., straight or curved) of the substrate 116.

As will be described later in greater detail, end assemblies 108 and 110 include electrically conductive components that are coupled to the LED units 118 via the electrically conductive paths of the substrate 116. End assemblies 108 and 110 include moveable portions that enable a user to alter a position (e.g., angle of rotation and offset distance) of the LED units 118 relative to a fluorescent light fixture while the LED lighting unit 100 remains coupled to the fixture. Knurling, cross-hatching, or other textured surfaces (not shown) may be present on one or both end assemblies 108 and 110, sidewall 102, or elsewhere on LED lighting unit 100 to minimize slipping when grasped by a user.

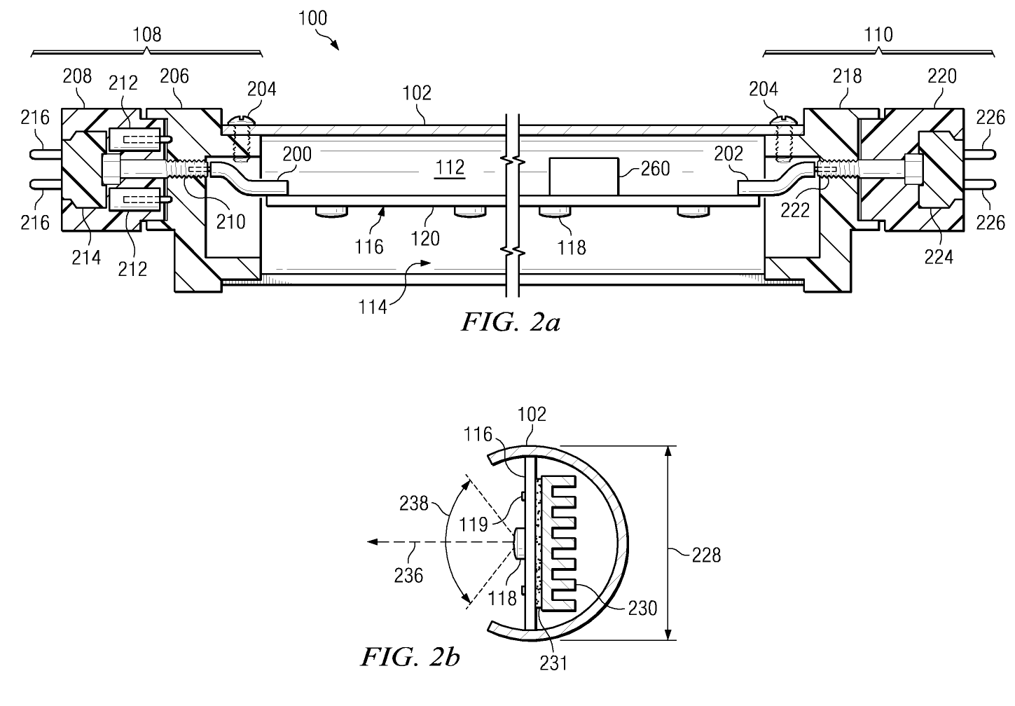

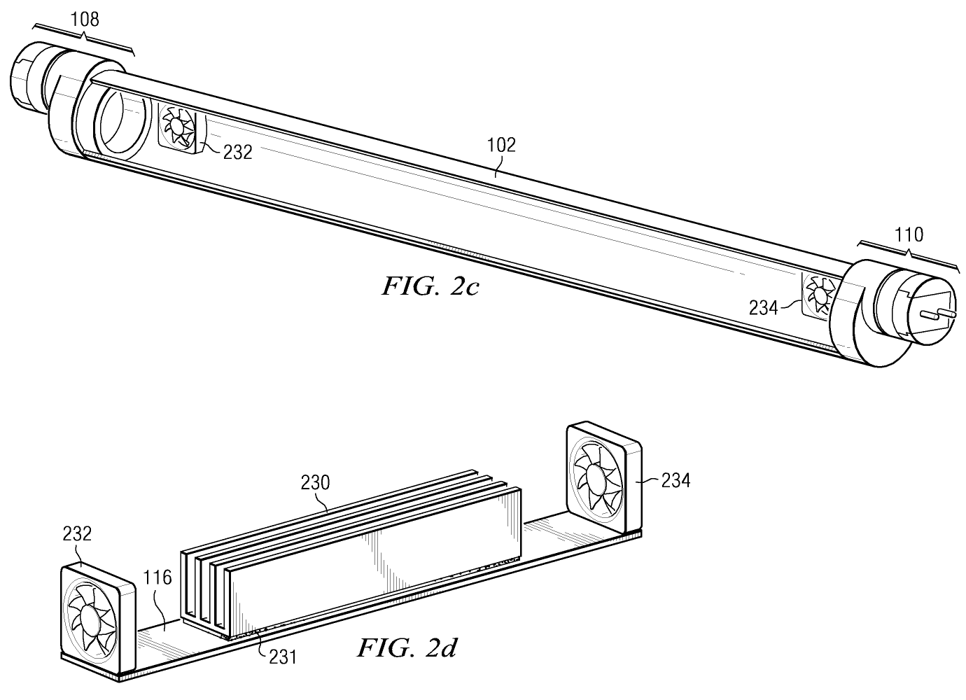

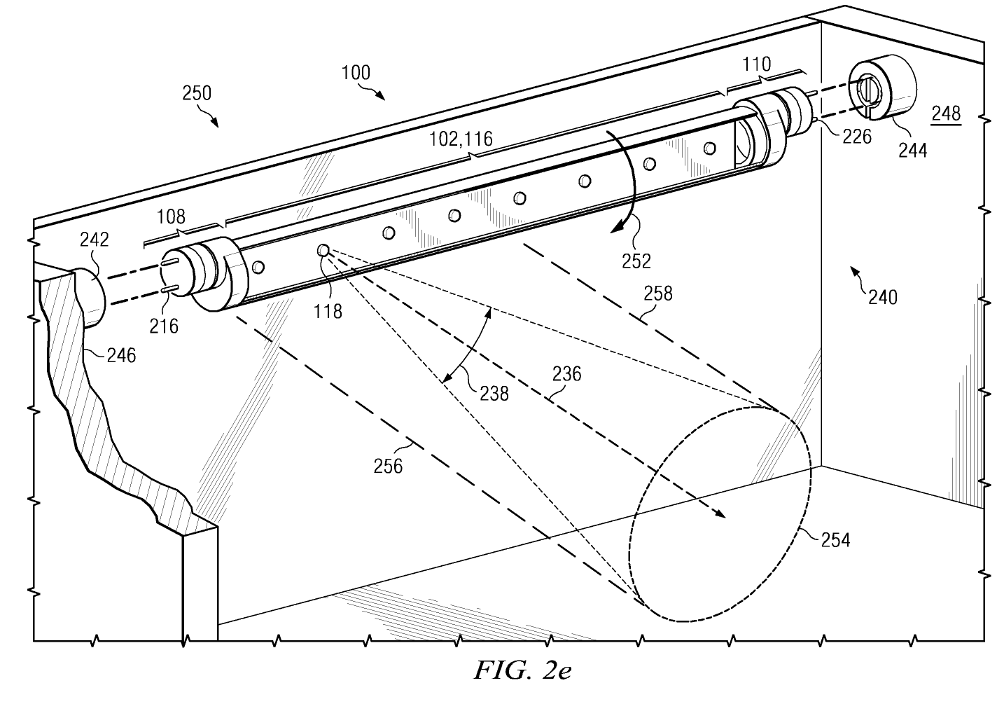

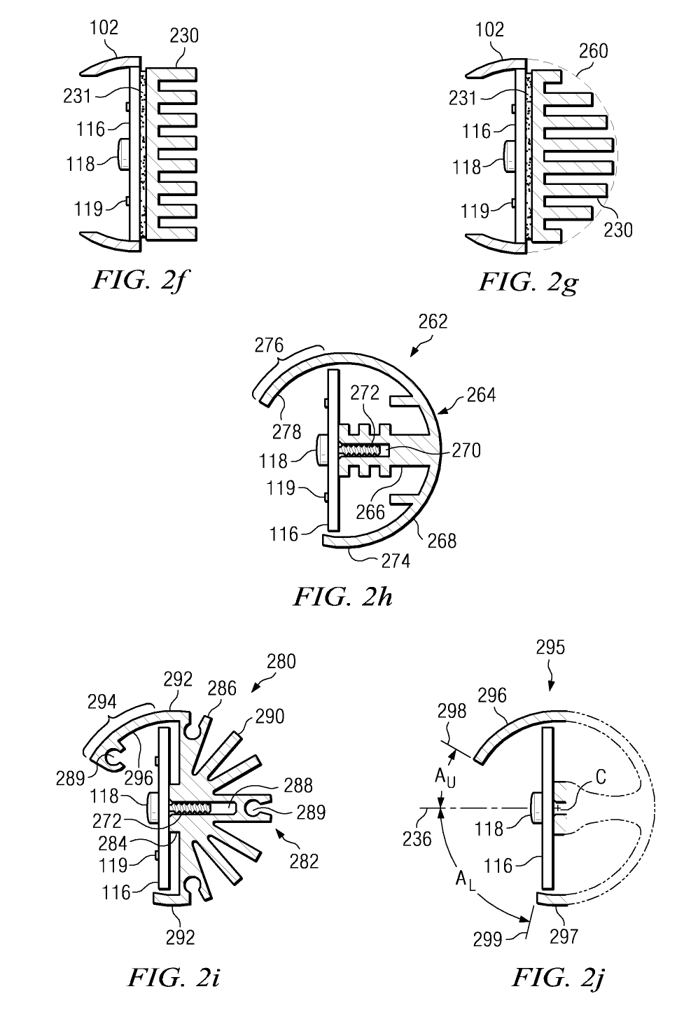

Referring to FIG. 2a, a cross-sectional view of one embodiment of the LED lighting unit 100 along lines 2a-2a of FIG. 1 is illustrated. In the present embodiment, the substrate 116 is substantially planar with the surface 120 being positioned within the cavity 112 so as to face the aperture 114. In this embodiment, the substrate 116 is formed of an aluminum sheet for increased heat transfer and the electrically conductive paths 119 of the substrate are traces mounted on the surface of the sheet with appropriate electrical insulation. In other embodiments, the conductive paths may be discrete wires connected to the various components. In still other embodiments, the substrate 116 may be formed of printed circuit board (PCB) material, silicon, plastic, other suitable materials, or combinations thereof. The electrically conductive paths may be photo-etched metallic (e.g., copper or aluminum) traces, metallic buses, or other known electrical conductors.

Connectors 200 and 202 are coupled to substrate 116 and provide an electrical connection between the substrate and the end assemblies 108 and 110, respectively. The connectors 200 and 202 may be constructed of a conductive material (e.g., metal), may have a passage formed therein containing a conductive material, or may provide structural support for a conductor (e.g., a wire) coupled to an external surface thereof. In some embodiments, one or more fasteners 204 (e.g., screws) may be used to secure the sidewall 102 to the end assemblies 108 and 110.

End assembly 108 includes body members 206 and 208 that are coupled via a fastener 210 (e.g., a bolt) so as to allow rotation of body member 206 relative to body member 208. Body member 206 is coupled to sidewall 102. A selective adjustment mechanism may include one or more locking components 212 (e.g., spring plungers) that may be used to prevent rotation between the body members 206 and 208 unless sufficient force is applied to overcome the locking components. Fastener 210 may provide an electrical path between connector 200 and portions of contact member 214 of body member 208.

Contact member 214 may couple the LED lighting unit 100 to an electrical receptacle of a fluorescent light fixture (not shown) via extensions 216 (e.g., metal prongs). The contact member 214 will typically comprise both electrically conductive portions and electrically non-conductive portions. In the present embodiment, extensions 216 serve both as mounting members (physically aligning and holding the LED lighting unit 100 in the light fixture) and as electrical contacts (receiving electrical power from the light fixture). However, it is understood that in other embodiments the mounting portions and the contact portions of the end assembly 108 may be distinct from one another. In addition, while the contact arrangement provided by the extensions 216 of the LED lighting unit 100 may generally duplicate the contact arrangement of the electrical receptacle of the conventional fluorescent bulb being replaced, LED lighting unit 100 will not necessarily draw electric power in the same manner as a conventional fluorescent bulb. For example, a conventional fluorescent bulb may draw electricity from prongs at both ends of the bulb, whereas the LED lighting unit 100 may draw electricity from one end only. In some embodiments, contact member 214 may slide relative to body member 208 to provide an offset between the contact member 214 (which is fixed in place in the light fixture) and LED units 118.

End assembly 110 includes body members 218 and 220 that are coupled via a fastener 222 (e.g., a bolt) so as to allow rotation of body member 218 relative to body member 220. Body member 218 is coupled to sidewall 102. Although not present in the current embodiment, end assembly 110 may include one or more locking components that may be similar or identical to the locking components 212 of end assembly 108. Fastener 222 may provide an electrical path between connector 200 and a contact member 224 of body member 220.

Contact member 224 may couple the LED lighting unit 100 to the electrical receptacle of the fluorescent light fixture (not shown) via extensions 226 (e.g., metal prongs). The contact member 224 will typically comprise both electrically conductive portions and electrically non-conductive portions. As with the extensions 216 of contact member 214, extensions 216 may serve both as mounting members and as electrical contacts. However, it is understood that in other embodiments the mounting portions and the contact portions of the end assembly 110 may be distinct from one another as previously described with respect to extensions 216. In some embodiments, contact member 224 may slide relative to body member 110 to provide an offset between the contact member 224 (which is fixed in place in the light fixture) and LED units 118.

With additional reference to FIG. 2b, a cross-sectional view of one embodiment of the sidewall 102 and substrate 116 along line 2b-2b of FIG. 1 is illustrated. For purposes of example, the sidewall 102 may have a diameter (denoted by reference number 228 in FIG. 2) in the range of about 0.625 inches (15.9 mm) to about 1.3 inches (33.0 mm), similar to that of the conventional fluorescent lamps being replaced. However, different diameters of sidewalls may be used depending on the particular application for which the LED lighting unit 100 is intended. In the illustrated embodiment, sidewall 102 is formed of extruded aluminum, but may be formed of steel, zinc, plastic, other suitable materials, or combinations thereof. Although not shown in the present example, when the sidewall 102 is formed by extrusion, spaced-apart ridges may be formed as an integral part thereof to facilitate the installation of internal components such as the substrate 116.

One or more heatsinks 230 (e.g., a finned heatsink array) may be mounted on the rear side of substrate 116 inside a portion of the cavity 112 bounded by the sidewall 102 and the substrate itself (i.e., on the side opposite the surface 120). The heatsinks 230 are thermally coupled, e.g., via a thermal compound 231, to the substrate 116 and/or LED units 118, and serve to transfer away excess heat generated by the LED units during operation.

Referring also to FIGS. 2c and 2d, heated air may be allowed to exit the LED lighting unit 100 without aid, or may be pulled or pushed from the area of the heatsink 230 by one or more fans 232 and 234. Such fans may also serve to remove heat generated by other components of the LED lighting unit 100. Different fan configurations and placement may be used with, for example, one fan (e.g., fan 232) operating in intake mode to pull cooler air into the LED lighting unit 100 and push it across the heatsink 230 and another fan (e.g., fan 234) operating in exhaust mode to pull air off of the heatsink and push the heated air out of the LED lighting unit. Such an arrangement may optimize the movement of air through the cavity 112 and across the heatsinks 230. Such fans may be coupled to the sidewall 102 (FIG. 2c), may be coupled to the substrate 116 (FIG. 2d), or may be located elsewhere (e.g., in the end assemblies 108 and 110). If necessary, additional fans and/or exhaust ports (not shown) may be provided for cooling the LED lighting unit 100. In some embodiments, passive exhaust ports or vent holes formed through the substrate 116, sidewall 102, and/or other components may be used in addition to or in place of fans to aid heat in escaping from cavity 112.

Referring again to FIG. 2b, the LED units 118 may be a directional light output type. In other words, each LED unit 118 may have a defined light output direction 236. In the present example, the light output direction 236 is the direction from the LED unit 118 to the center of an area illuminated by the LED unit, and the useful edges of the lighted area will define a lighting angle 238. The light output direction 236 for an LED unit 118 is typically, though not necessarily, perpendicular to the base of the unit. The lighting angle 238 may be selected for a particular application. For example, an LED lighting unit 100 that provides a lighting angle 238 that is within a range of 55-135 degrees may be preferred for use in a lighted display case, and an LED lighting unit with a display angle within the range from 60-95 degrees may be more preferred.

Referring to FIG. 2e, one embodiment of an environment within which the LED lighting unit 100 of FIG. 1 may be used is illustrated. In the present example, the LED lighting unit 100 is installed in a display case light fixture 240. Light fixture 240 comprises a pair of sockets 242 and 244 mounted on respective portions 246 and 248 of display case 250. In the illustrated embodiment, sockets 242 and 244 are of the two-prong type commonly used for fluorescent lamps. The sockets are connected via wires (not shown) to a conventional ballast (not shown) of the type typically used for fluorescent lamps. It will be appreciated that since sockets 242 and 244 are rigidly affixed to their respective portions of the display case 250, the extensions 216 and 226 of the LED lighting unit 100 must be aligned with the contacts of the sockets in order to engage them.

As shown with respect to a single LED unit 118, when the LED lighting unit 100 is initially plugged into the sockets 242 and 244, the light output direction 236 will be directed outwardly from the LED unit 118, but not necessarily in the direction desired for lighting the display case 250. However, as the direction in which the LED unit 118 faces may be rotated independently of the sockets 242 and 244 (as indicated by arrow 252), the light output direction 236 can be adjusted by a user through a range of angles that moves a lighted area 254 along a track indicated by lines 256, 258 such that the desired lighting direction is achieved. As will be described below in greater detail, the force needed to rotate the LED unit 118 relative to sockets 242 and 244 is sufficient to keep the LED unit aimed where desired but is insufficient to dislodge the end assemblies 108 and 110 from the sockets.

Referring again specifically to FIG. 2a, in some embodiments, a transformer, converter, or other control circuitry 260 may be provided to receive alternating current from a ballast unit (not shown) of a fluorescent light fixture and perform any needed current and/or voltage conversions before supplying power to the LED units 118. Inclusion of the converter 260 may eliminate the need to change, remove, or re-wire the existing fluorescent ballast unit when installing the retrofit LED lighting unit 100 in place of a conventional fluorescent bulb. In other embodiments, converter 260 may be replaced and/or supplemented by a voltage regulator, rectifier-type or stepping-type power supply, filter, or other known electrical/electronic devices as necessary to convert the voltage, current, and electrical waveform available from the pre-existing light fixture (including a ballast unit, if present) to the voltage, current, and electrical waveform required by the LED lighting unit 100.

Although the converter 260 is illustrated in the present example as being positioned in a portion of the cavity 112 bounded by the sidewall 102 and the substrate 116 itself (i.e., on the side opposite the surface 120), it is understood that the converter may be positioned elsewhere. Furthermore, the converter 260 may be coupled to the sidewall 102, substrate 116 (as shown), and/or other components (e.g., one of the end assemblies 108 or 110).

Referring now to FIG. 2f, a cross-sectional view of another embodiment of the sidewall 102 is illustrated. In the present embodiment, the sidewall 102 is partially or completely open at the rear and may form one or more side shields near the substrate 116. In this embodiment, heatsink 230 may be exposed rather than positioned in cavity 112. In other embodiments (not shown), substrate 116 may have no sidewall 102 at all.

Referring now to FIG. 2g, a cross-sectional view of another embodiment of the sidewall 102 is illustrated. In the present embodiment, the sidewall 102 is partially or completely open at the rear and may form one or more side shields near the substrate 116. The heatsink 230 may be exposed rather than positioned in cavity 112. In contrast to FIG. 2f, the heatsink 230 in the present example may be configured to maintain a generally circular cross-section (illustrated by line 260) of the LED lighting unit 100.

Referring now to FIG. 2h, a cross-sectional side view of an LED lighting unit in accordance with a further embodiment is illustrated. Such an LED lighting unit may be used in either retrofit or new construction applications. LED lighting unit 262 includes a hybrid sidewall 264 that provides both structural support for an LED substrate 116 and heat management functionality. The hybrid sidewall 264 includes a support portion 266 and a sidewall portion 268. The support portion 266 is adapted for both structural and thermal connection to the LED lighting substrate 116. In the embodiment shown, one or more passageways 270 (e.g., holes or slots) are provided in support portion 266 to receive fasteners 272 (e.g., screws, bolts, etc.) inserted through the substrate 116. When tightened, the fasters 272 hold the substrate 116 firmly against the support portion 266. The support portion 266 preferably contacts the substrate 116 in an area directly behind the LED units 118, since the LED units are major heat producers. Further, the support portion 266 preferably does not contact the entire rear portion of the substrate 116. Rather, in preferred embodiments, the support portion 266 contacts less that 50 percent of the rear area of the substrate 116, and in more preferred embodiments, the support portion contacts less that 33 percent of the rear area of the substrate.

The sidewall portion 268 of the hybrid sidewall 264 is structurally and thermally connected to the support portion 266. There does not need to be any contact directly between the LED substrate 116 and the sidewall portion 268. For retrofit applications, the ends of the sidewall portion 268 may be connected to retrofit end assemblies 108, 110 as previously described. For new construction applications, the sidewall portion 268 may be connected to other end assemblies (not shown) or other mounting structures known for use with lighting fixtures. Preferably, the support portion 266 and the sidewall portion 268 are formed from the same material as a single unitary structure, for example, by extrusion. The hybrid sidewall 264 may have a constant cross-section to facilitate production by extrusion. In a preferred embodiment, the hybrid sidewall is produced from a material having relatively high thermal conductivity, e.g., aluminum.

The sidewall portion 268 may include a wall 274 having a substantially circular cross-section that at least partially encircles the LED substrate 116 as illustrated in FIG. 2h. The front end of the wall 274 may be approximately flush with the end of the substrate 116 (as seen in the lower portion of FIG. 2h), or the front end of the wall may extend substantially in front of the end of the substrate, forming a shade 276 (as seen at the upper portion of FIG. 2h). Shade 276 prevents light from the LED units 118 from shining in undesirable directions, and may further reflect light from its inner surface 278 into more desirable directions. Heat drawn from the LED substrate 116 by the support portion 266 is conducted into the sidewall portion 268, where it can be efficiently dissipated into the environment due to the relatively large surface area of the sidewall portion.

Referring now to FIG. 2i, a cross-sectional side view of an LED lighting unit in accordance with a yet another embodiment is illustrated. As with the embodiment shown in FIG. 2h, this LED lighting unit may be used in either retrofit or new construction applications. LED lighting unit 280 includes a hybrid sidewall 282 that provides both structural support for an LED substrate 116 and heat management functionality. The hybrid sidewall 282 includes a support portion 284 and a sink portion 286. The support portion 284 is adapted for both structural and thermal connection to the LED lighting substrate 116. In the embodiment shown, one or more passageways 288 (e.g., holes or slots) are provided in support portion 284 to receive fasteners 272 inserted through the substrate 116. When tightened, the fasters 272 hold the substrate 116 firmly against the support portion 284. The support portion 284 preferably contacts the substrate 116 in an area directly behind the LED units 118, and preferably does not contact the entire rear portion of the substrate. Rather, in preferred embodiments, the support portion 284 contacts less that 50 percent of the rear area of the substrate 116, and in more preferred embodiments, the support portion contacts less that 33 percent of the rear area of the substrate.

The sink portion 286 of the hybrid sidewall 282 is structurally and thermally connected to the support portion 284. There does not need to be any contact directly between the LED substrate 116 and the sink portion 286. For retrofit applications, the ends of the sink portion 286 may be connected to retrofit end assemblies 108, 110 as previously described. For new construction applications, the sink portion 286 may be connected to other end assemblies (not shown) or other mounting structures known for use with lighting fixtures. Passageways 289 may be formed in the cross-section of the hybrid sidewall 282 to facilitate connection (e.g., by screws) of such end assemblies. Preferably, the support portion 284 and the sink portion 286 are formed from the same material as a single unitary structure, for example, by extrusion. The hybrid sidewall 282 may have a constant cross-section to facilitate production by extrusion. In a preferred embodiment, the hybrid sidewall is produced from a material having relatively high thermal conductivity, e.g., aluminum.

The sink portion 286 may include a one or more fins 290. The fins 290 may extend in a radial direction away from the support portion 284 or have other configurations. The sink portion 286 may also include one or more wall portions 292 that at least partially encircle the LED substrate 116. The wall portions 292 may extend from the support portions 284 or from the fins 290. The front end of the wall portions 292 may be approximately flush with the end of the substrate 116 (as seen in the lower portion of FIG. 2i), or the front ends of the wall portions may extend substantially in front of the end of the substrate, forming a shade 294 (as seen at the upper portion of FIG. 2i). As in the previous embodiment, the shade 294 prevents light from the LED units 118 from shining in undesirable directions, and may further reflect light from its inner surface 296 into more desirable directions. Heat drawn from the LED substrate 116 by the support portion 284 is conducted into the sink portion 286, where it can be efficiently dissipated into the environment due to the relatively large surface area of the fins 290 and other components.

Referring now to FIG. 2j, there is illustrated an LED lighting unit having a defined angular lighting aperture in accordance with another embodiment. As previously described, LED lighting units may include wall portions that at least partially encircle the LED substrate as illustrated in FIGS. 2b, 2f, 2g, 2h and 2i. When such wall portions extend on the front side (i.e., the light-producing side) of the LED substrate, they may be termed shades. Referring to FIG. 2j, LED lighting unit 295 includes an LED substrate 116 with LED unit 118 and upper and lower wall portions 296 and 297, respectively. The wall portions 296 and 297 at least partially encircle the LED substrate 116 about center point C. The remaining portion of the LED lighting unit 295 may have any configuration, and thus is shown in broken line. The center of light output for LED unit 118 is indicated by axis 236, which also passes through center point C. An upper light angle A_{U} is defined as the angle between the light output axis 236 and a first line 298 passing from front end of the upper wall 296 to the center point C. A lower light angle A_{L} is defined as the angle between the light output axis 236 and a second line 299 passing from front end of the lower wall 297 to the center point C. The upper and lower light angles A_{U} and A_{L} control how much light is released in the upward and downward directions, respectively, relative to the light output axis 236. Put another way, the smaller the upper angle A_{U}, the greater the shade provided by the upper wall 296, and thus the less light that is directed upward. Such shade may be important to avoid shining light from LED unit 118 directly into the eyes of customers disposed in the direction that the LED lighting unit 295 is pointing. Similarly, the smaller the lower angle A_{L}, the greater the shade provided by the lower wall 297, and thus the less light that is directed downward. Typically, downward light is desirable in display case applications, so the lower shade will often be smaller than the upper shade.

Referring still to FIG. 2j, in one embodiment suitable for display case applications, the LED lighting unit 295 will have an upper light angle A_{U} within the range of about 25 degrees to about 35 degrees, and a lower light angle A_{L} within the range of about 70 degrees to about 80 degrees. In a more preferred embodiment, the LED lighting unit 295 will have an upper light angle A_{U} within the range of about 29 degrees to about 31 degrees, and a lower light angle A_{L} within the range of about 74 degrees to about 76 degrees. In another embodiment, suitable for general lighting applications, the LED lighting unit 295 will have an upper light angle A_{U} within the range of about 50 degrees to about 85 degrees, and a lower light angle A_{L} within the range of about 50 degrees to about 85 degrees. In a more preferred embodiment, the LED lighting unit 295 will have an upper light angle A_{U} within the range of about 58 degrees to about 75 degrees, and a lower light angle A_{L} within the range of about 58 degrees to about 75 degrees. In a still more preferred embodiment, the LED lighting unit 295 will have an upper light angle A_{U} within the range of about 58 degrees to about 65 degrees, and a lower light angle A_{L} within the range of about 58 degrees to about 65 degrees. All of these embodiments are suitable for use in retrofit applications or new construction applications, through the use of suitable end connectors or other connectors as previously described.

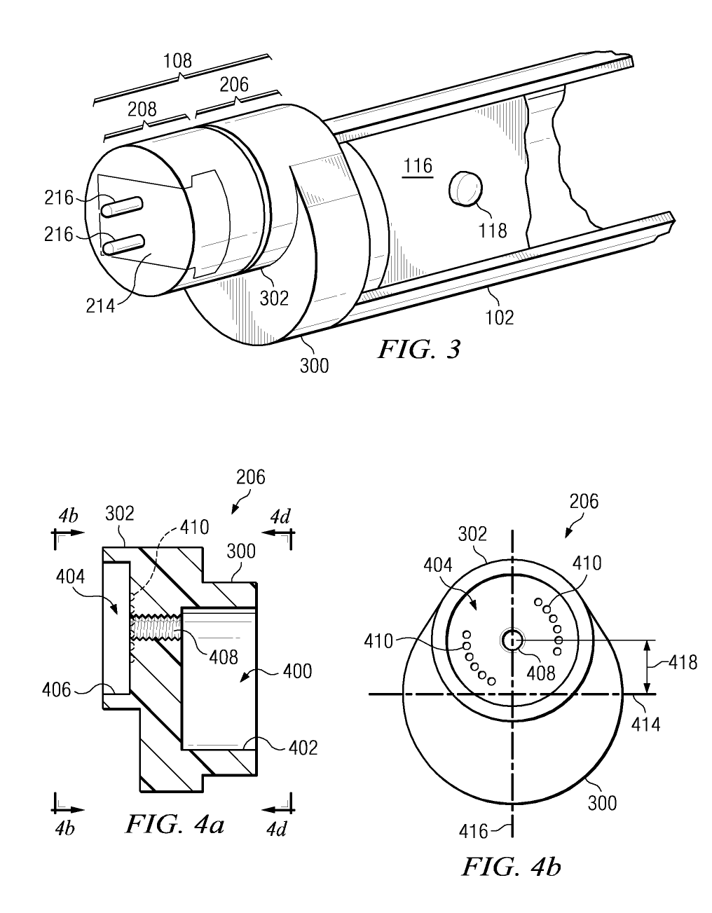

Referring now to FIG. 3, a perspective view of one embodiment of end assembly 108 of FIG. 1 is illustrated. As the end assembly 110 of FIG. 1 may be similar or identical to the end assembly 108 described in detail below, the end assembly 110 is not described in detail herein. As described with respect to FIG. 2a, end assembly 108 includes body members 206 and 208 that are coupled so as to allow rotation of body member 206 relative to body member 208. In the present example, body member 206 includes first and second portions 300 and 302. First portion 300 is positioned proximate to sidewall 102 and may have a shape that tapers at one end and is rounded at the other end (i.e., a pear shape). Second portion 302 is positioned between first portion 300 and body member 208 and may have a substantially circular shape. As illustrated, second portion 302 may be positioned at the tapered end of first portion 300 (i.e., offset as opposed to being generally centered with body member 300 around a single axis), although the first and second portions may be positioned relative to one another in many different ways. It is understood that the first and second portions 300 and 302 may be rigidly coupled or may be formed as a single body member. In other embodiments, first and second portions may be of identically sized and, in still other embodiments, first and second portions may be of different sizes but may not be offset.

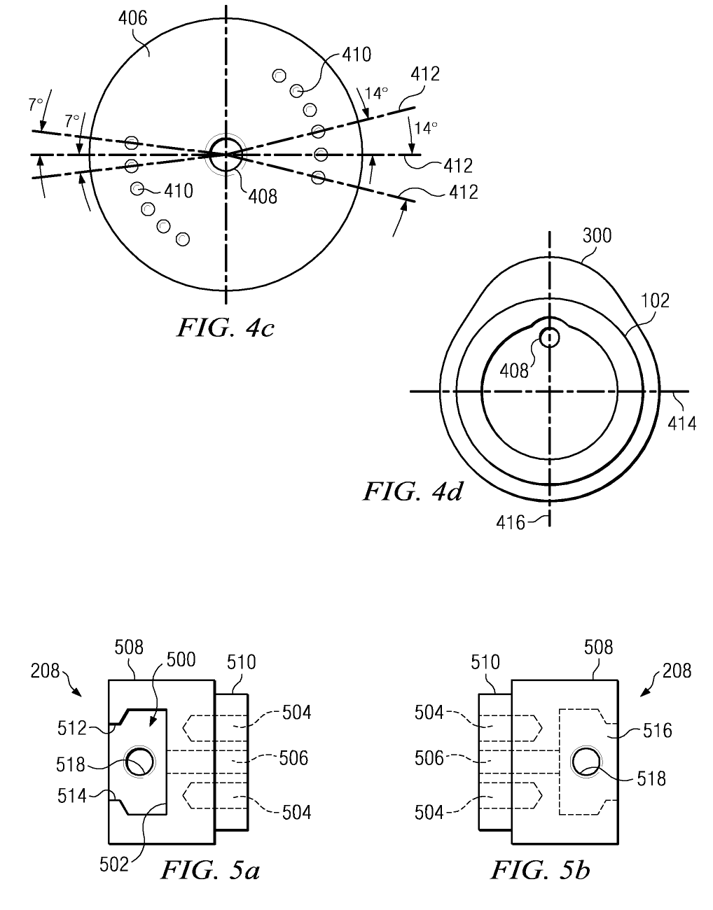

With additional reference to FIG. 4a, a side cross-sectional view of one embodiment of the body member 206 of FIG. 3 is illustrated as having a cavity 400 defined by a surface 402 in first portion 300. The cavity 400 may form part of the cavity 112 (FIG. 1). The body member 206 also includes a cavity 404 defined by a surface 406 in second portion 302. The cavity 404 is sized and shaped to receive a portion of the body member 208 and to allow the body member 208 to rotate with respect to the body member 206. A bore 408 may couple the cavities 400 and 404 to provide a passage for the fastener 210 and/or connector 200. In the present example, the bore 408 is centered in the second portion 302 and defines the axis of rotation for member 208 relative to member 206.

With additional reference to FIG. 4b (providing a view of body member 206 from the perspective of line A-A of FIG. 4a) and FIG. 4c, at least a portion of the surface 406 may include part of a selective adjustment mechanism formed by rotational locking features 410 (e.g., indentations) configured to engage locking components 212 (FIG. 2a) of body member 208. In the present example, the body member 208 rotates relative to the body member 206 about bore 408 and the rotational locking features 410 are positioned in two curved rows on substantially opposite sides of the bore 408. The two curved rows are offset from each other by seven degrees. Each rotational locking feature 410 in a row is spaced from adjacent features by approximately fourteen degrees, and the offset between the two rows means that a line 412 passing through the center of a feature and the bore 408 will pass between two features in the opposite row. Accordingly, as the two rows of features are offset from one another by seven degrees, one of the two locking components 212 will engage a rotational locking feature 410 for every seven degrees of rotation while the other locking component will abut the space between two locking features (or the space at the end of a row). It is understood that the use of seven degrees and fourteen degrees is for purposes of example only, and that the number of rotational locking features 410 and the offset between features and rows may vary. Furthermore, a single locking component 212 may be provided to engage locking features 410, or locking components/locking features may be incorporated in each end assembly 108 and 110 in an offset manner.

Referring to FIG. 4b (providing a view from the perspective of line A-A of FIG. 4a) and FIG. 4d (providing a view from the perspective of line B-B of FIG. 4a), an amount of offset provided by the location of the portion 302 relative to the portion 300 is illustrated. As can be seen in FIG. 4d, the sidewall 102 may be substantially centered relative to an x-axis 414 and a y-axis 416 in the lower, pear-shaped area of the portion 300. However, in FIG. 4b, the portion 302 is centered on the x-axis 414 but displaced along the y-axis 416 by a defined distance (denoted by reference number 418) and positioned in the upper, more tapered area. The offset provided by the distance 418 enables the LED lighting unit 100 to be mounted (e.g., using portion 302) in a conventional fluorescent light fixture while positioning the LED units 118 lower (e.g., using portion 300) than would be possible without the offset for the same configuration of the LED lighting unit.

Referring now to FIGS. 5a and 5b, opposing cross-sectional side views of one embodiment of the body member 208 of FIG. 3 are illustrated. As shown in FIG. 5a, body member 208 may have a channel 500 defined by a surface 502. The body member 208 also includes one or more cavities 504 in which locking components 212 may be positioned. A bore 506, configured to receive the fastener 210, is positioned to align with the bore 408 of the body member 206.

In the present example, the body member 208 includes a substantially cylindrical first portion 508 having a first diameter and a substantially cylindrical second portion 510 having a second diameter that is smaller than the first diameter. The second diameter is such that the second portion 510 can fit at least partially into the cavity 404 of the body member 206, while the first diameter is such that the first portion 508 cannot fit into the cavity 404. It is understood that when the second portion 510 is aligned with the cavity 404, at least one locking component 212 may be aligned with one of the locking features 410.

The channel 500, which is formed in the first portion 508, may include lips 512 and 514 that extend along part or all of the channel's length. As shown in FIG. 5b, the channel 500 may be closed on one end by an end wall 516 with a hole 518 formed therein for a set screw (not shown) and is open ended on the other end. The hole 518 may or may not be threaded depending on the design of the set screw, as will be described below in greater detail with respect to contact member 214.

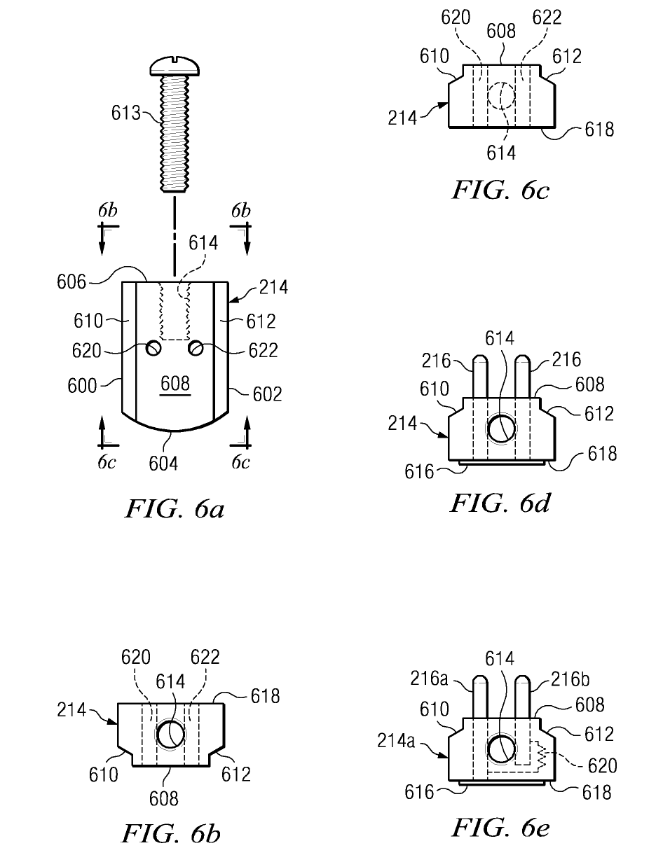

With additional reference to FIGS. 6a-6d, one embodiment of contact member 214 is illustrated. It is understood that, while contact member 214 is described as part of body member 208 in the present disclosure, it may be considered as separate in some embodiments. The contact member 214 of the present embodiment includes substantially parallel sides 600 and 602, a curved end 604, and a flat end 606.

An outer face 608 of contact member 214 (i.e., the side of the contact member facing the lips 512 and 514 of FIG. 5a) may include shoulders 610 and 612 that abut the inside edges of the lips. Accordingly, the contact member 214 may slide along the channel 500 (FIG. 5a) while being retained in the channel by the lips 512 and 514. In the present embodiment, the contact member 214 may be restrained from sliding out of the open end of the channel 500 by a set screw 613 that passes through hole 518 (FIG. 5b) and into a hole 614 in the flat end 606. The set screw 613 may be formed of a non-conductive material such as plastic. A contact plate 616 (FIG. 6d) abuts an inner face 618 of contact member 214. Contact plate 616, which is electrically conductive, is electrically coupled to extensions 216 that pass through the contact member 214 via holes 620 and 622.

Referring now to FIG. 6e, there is illustrated a contact member having an alternative configuration that may be used in some embodiments. Contact member 214a is similar in most respects to contact member 214 previously described, however, the electrical configuration of the prongs 216 and contact plate 616 is different. Specifically, only one of the prongs (denoted 216a) is electrically connected directly to the contact plate 616. The second prong (denoted 216b) is electrically connected to the first prong 216a (and thus also to the contact plate 616) via an electrical resistor 620. The alternative configuration of contact member 214a may be suitable for lighting units used in retrofit applications where certain types of fluorescent-type ballast units will be retained. The lighting unit may use alternative contact members 214a at both ends of the unit, or it may use an alternative contact member 214a at one end and a contact member 214 at the other end.

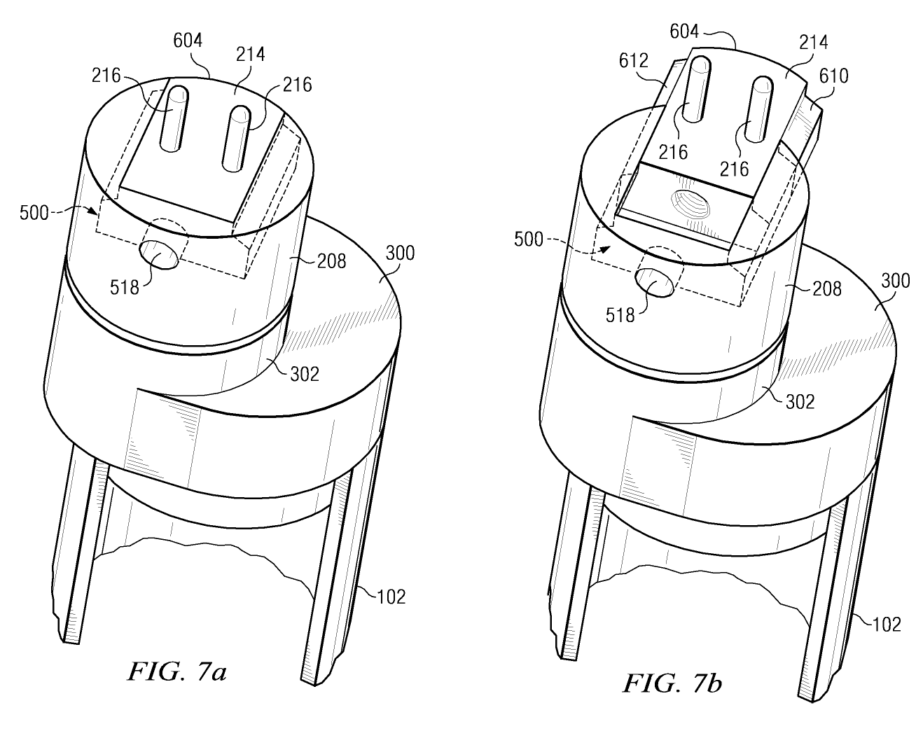

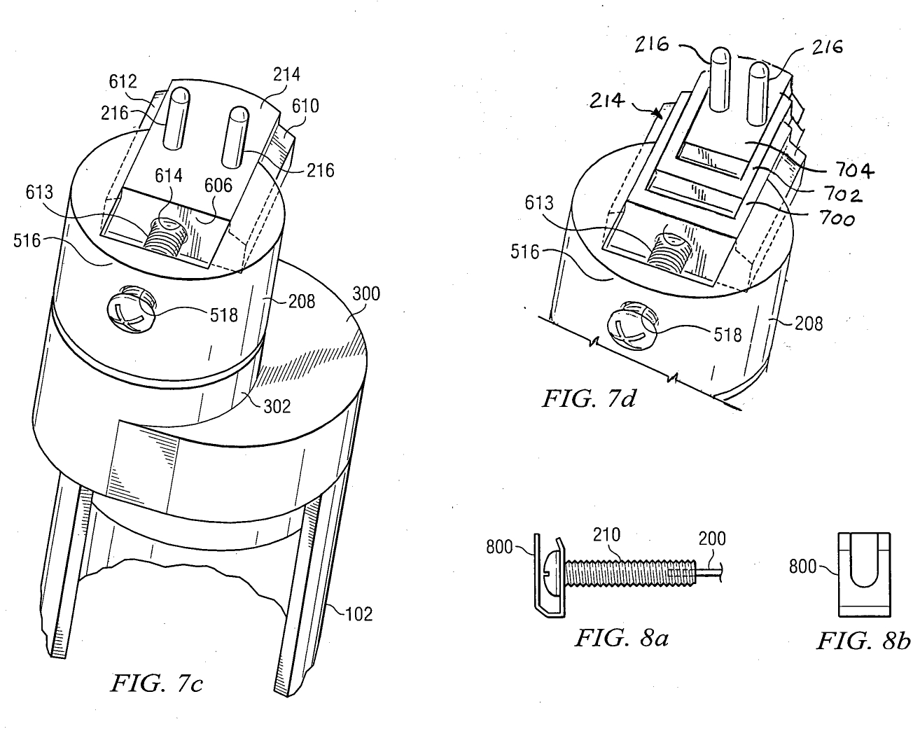

With additional reference to FIGS. 7a and 7b, an offset provided by movement of the contact member 214 relative to the body member 208 is illustrated. More specifically, FIG. 7a illustrates the contact member 214 in a non-extended position relative to the body member 208, while FIG. 7b illustrates the contact member in at least a partially extended position. The offset between the body member 208 (and the remainder of the end assembly 108) and the contact member 214 (which may be coupled to a light fixture) enables a user to alter a distance between the LED units 118 and the light fixture into which the LED lighting unit 100 is placed. For purposes of clarity, end wall 516 and set screw 613 are not shown.

With additional reference to FIG. 7c, an offset provided by movement of the contact member 214 relative to the body member 208 is illustrated with the addition of end wall 516 and set screw 613. FIG. 7c illustrates the contact member 214 in at least a partially extended position, with set screw 613 extending from the outside (relative to contact member 214) of the end wall 516, through hole 518 and into hole 614 of the contact member. The offset between the body member 208 (and the remainder of the end assembly 108) and the contact member 214 (which may be coupled to a light fixture) enables a user to alter a distance between the LED units 118 and the light fixture into which the LED lighting unit 100 is placed.

In operation, the contact member 214 may be moved within channel 500 by rotating the set screw 613 in a clockwise or counterclockwise direction. Either the hole 518 and/or the hole 614 may be threaded. For example, if the hole 518 is threaded and the set screw 613 is coupled to the contact member 214 in a rotatable but non-threaded manner, then rotating the set screw will increase or decrease the distance between the end wall 516 and the end 606 of the contact member. Similarly, if the hole 614 is threaded and the hole 518 is not, then rotating the set screw will increase or decrease the maximum distance between the end wall 516 and the end 606 of the contact member. In the latter case, the weight of the LED lighting unit 100 may be sufficient to cause the unit to slide down (relative to contact 214) until it hangs at the end of screw 613 or, alternatively, means may be needed to ensure that the set screw 613 does not push out of the hole 518. It is understood that the set screw 613 is only one example of a mechanism by which the contact member 214 may be adjusted and that many different adjustment mechanisms may be used in addition to or in place of the set screw.

Referring to FIG. 7d, one embodiment of a telescoping contact member 214 is illustrated. Contact member 214 includes multiple sections 700, 702, and 704 which may be extended and retracted in a telescoping manner to provide a desired amount of offset. One or more set screws, pins, or other locking members (not shown) may be used to secure the telescoping sections 700, 702, and 704 in place.

Referring to FIGS. 8a and 8b, fastener 210 is illustrated with a conductive contact 800, which is a spring contact in the present embodiment. The contact 800 is designed to exert pressure to maintain an electrical connection between fastener 210 and contact plate 616 (FIG. 6d), thereby electrically coupling fastener 210 to extensions 216. Accordingly, an electrical transmission path is created from extensions 216 (which may be coupled to electrical contacts in a fluorescent light fixture) through fastener 210 via contact plate 616 and contact 800, and from fastener 210 to LED units 218 via connector 200 and electrically conductive paths of substrate 116.

In operation, LED lighting unit 100 may be provided with an offset by means of set screw 613 in end assembly 108 and a similar set screw in end assembly 110. The LED lighting unit 100 may then be placed into a fluorescent light fixture in the same manner as would a traditional fluorescent light bulb. Once in place, a lighting angle may be manipulated by rotating the substrate 116 as enabled by the rotational locking features 410 and corresponding locking components 212. As such, the lighting provided by the LED lighting unit 100 may be adjusted in two ways without making any changes to the fluorescent light fixture in which the LED lighting unit is placed. Firstly, a distance between the LED units 118 and the fluorescent light fixture may be adjusted within a range defined by the offset allowed by movement of the contact member 214 relative to the member 208. It is noted that this “dynamic” offset is in addition to the “static” offset provided by the relative positions of the first and second portions 300 and 302 of the body member 206. Secondly, an angle of light provided by the LED units 118 may be adjusted by rotating the direction in which the LED units are facing. Similar operations may be performed with respect to end assembly 110. Accordingly, a LED lighting unit 100 is described that not only fits into a conventional fluorescent light fixture, but is also adjustable.

It is understood that the LED lighting unit 100 is not limited to use in display cases and may be used in many different environments where it may be desirable to replace an existing fluorescent light. Furthermore, the advantages offered by the adjustability of the LED lighting unit 100 may be desirable in many different locations, including indoor locations such as stairwells (where the light may be directed in a desired direction) and outdoor locations (where light pollution has resulted in ordinances that limit an amount of light that can “escape” upwards at night). For example, other exemplary environments include undershelf lighting (e.g., in kitchens or work areas), perimeter lighting, and vehicle lighting. Accordingly, it is envisioned that the LED lighting unit 100 may be used to replace conventional fluorescent or incandescent bulbs in many different environments.

While the preceding description shows and describes one or more embodiments, it will be understood by those skilled in the art that various changes in form and detail may be made therein without departing from the spirit and scope of the present disclosure. For example, various embodiments or portions thereof may be combined or further separated. In addition, it is understood that terms such as “up,” “down,” “left,” “right,” “vertical,” and “horizontal” may be used herein to describe relative orientations and do not necessarily denote an absolute relationship or orientation between components.

What is claimed is:

1. A lighting unit adapted for installation in a light fixture that includes at least one socket containing electrical contacts, the lighting unit comprising:
a first end assembly adapted to interfit with a first portion of the light fixture that contains the socket, wherein the first end assembly includes electrically conductive contacts adapted to operably interfit with the socket;
a second end assembly coupled to the second end and adapted to interfit with a second portion of the light fixture;
a substrate mounted between the first and second end assemblies, the substrate including electrically conductive paths, wherein the first and second end assemblies are configured to allow rotation of the substrate relative to the first and second portions, respectively, of the light fixture;
a plurality of light emitting diode (LED) units positioned on the substrate, wherein each LED unit is coupled to the electrically conductive paths of the substrate; and
an electrical transmission path coupling the electrically conductive contacts in the first end assembly with the electrically conductive paths of the substrate.

2. The lighting unit of claim 1 wherein the first end assembly includes a selective adjustment mechanism configured to releasably hold an angular position of the substrate relative to the first portion of the light fixture, the selective adjustment mechanism allowing the angular position to be manually adjusted.

3. The lighting unit of claim 2 wherein the selective adjustment mechanism comprises a locking member in a first portion of the first end assembly and a locking feature in a second portion of the first end assembly, wherein the locking member engages the locking feature to maintain the angular position of the first portion of the first end assembly relative to the second portion of the first end assembly.

4. The lighting unit of claim 1 further comprising a curved sidewall extending between a first end coupled to the first end assembly and a second end coupled to the second end assembly, the sidewall at least partially defining a cavity and having at least one aperture formed therein to provide access to the cavity, wherein the substrate is positioned within the cavity with the LED units positioned to direct light out of the cavity via the aperture.

5. The lighting unit of claim 1 wherein the first end assembly includes a first portion coupled to the first end of the substrate and a second portion adapted to interfit with the first portion of the light fixture, wherein the first and second portions are rotatably coupled to one another to allow rotation of the first end of the substrate relative to the first portion of the light fixture.

6. The lighting unit of claim 5 wherein the first and second portions of the first end assembly are offset from one another, and wherein the offset defines a distance between a longitudinal axis of the substrate and a longitudinal axis extending through the first and second portions of the light fixture.

7. The lighting unit of claim 5 wherein the second end assembly includes a third portion coupled to the second end of the substrate and a fourth portion adapted to interfit with the second portion of the light fixture, wherein the third and fourth portions are rotatably coupled to one another to allow rotation of the second end of the substrate relative to the second portion of the light fixture.

8. The lighting unit of claim 1 wherein the first end assembly includes an extension configured to move between a retracted state and an extended state, wherein the extended state increases a distance between a longitudinal axis of the substrate and a longitudinal axis extending through the first and second portions of the light fixture compared to the retracted state.

9. The lighting unit of claim 8 wherein the extension is a sliding member configured to move at least a portion of the first end assembly along a path that is substantially perpendicular to the longitudinal axis extending through the first and second portions of the light fixture.

10. The lighting unit of claim 9 wherein the sliding member includes a plurality of telescoping sections.

11. The lighting unit of claim 8 wherein the extension includes a portion of the electrical transmission path.

12. The lighting unit of claim 11 wherein the portion of the electrical transmission path included by the extension includes the electrically conductive contacts.

13. The lighting unit of claim 1 further comprising a transformer configured to convert power received from the light fixture to power needed by the LED units.

14. The lighting unit of claim 1 further comprising a heatsink thermally coupled to the substrate.

15. An end assembly for an adjustable light emitting diode (LED) lighting unit comprising:
a first portion configured to be coupled to at least one of a sidewall of the LED lighting unit and a substrate of the LED lighting unit, the first portion including a first electrical transmission path;
a second portion configured to be coupled to an electrical receptacle of a fluorescent light fixture, the second portion having at least one conductive extension configured to engage the electrical receptacle and a second electrical transmission path coupling the conductive extension and the first electrical transmission path,
wherein one of the first and second portions includes a selective adjustment mechanism adapted to allow at least one of an angle of rotation and an offset distance of an LED unit located on the substrate to be altered between first and second positions relative to the fluorescent light fixture.

16. The end assembly of claim 15 wherein the selective adjustment mechanism includes a locking component in one of the first and second portions and a plurality of locking features adapted to engage the locking component in the other of the first and second portions, wherein the locking features are spaced apart to provide a defined range of adjustability of the angle of rotation.

17. The end assembly of claim 16 wherein the locking component is a spring-loaded member and the locking features are indentations.

18. The end assembly of claim 15 wherein the selective adjustment mechanism includes an extending member that increases the offset distance between the LED unit and the fluorescent light fixture when extended and decreases the distance when retracted.

19. The end assembly of claim 18 wherein the extending member is configured to slide within a channel formed in one of the first and second portions.

20. A lighting unit adapted for installation in a light fixture that includes at least one socket containing electrical contacts, the lighting unit comprising:
a sidewall extending between first and second ends;
a first end assembly coupled to the first end and adapted to interfit with a first portion of the light fixture that contains the socket;
a second end assembly coupled to the second end and adapted to interfit with a second portion of the light fixture;
a substrate mounted to the sidewall between the first and second end assemblies, the substrate including electrically conductive paths;
a plurality of light emitting diode (LED) units positioned on the substrate, wherein each LED unit is coupled to the electrically conductive paths of the substrate;
an electrical transmission path coupling the electrically conductive contacts in the first end assembly with the electrically conductive paths of the substrate; and
means for selectively adjusting at least one of an angle of rotation and an offset distance of at least one of the plurality of LED units relative to the light fixture.
